(19) United States
(12) Patent Application Publication
(10) Pub. No.: US 2008/0103745 A1
(43) Pub. Date: May 1, 2008

(54) System for predicting programmed ribosomal frameshift sites in genome sequences

(75) Inventors: Kyungsook Han, Seoul (KR); Sanghoon Moon, Incheon (KR); Yanga Byun, Seoul (KR)

Correspondence Address: GREENLEE WINNER AND SULLIVAN P C, 4875 PEARL EAST CIRCLE, SUITE 200, BOULDER, CO, 80301, US

(73) Assignee: INHA-INDUSTRY PARTNERSHIP INSTITUTE, Inchon (KR)

(21) Appl. No.: 11/680,178

(22) Filed: Feb. 28, 2007

(30) Foreign Application Priority Data
Oct. 31, 2006 (KR) 10-2006-106383

(51) Int. Cl. G06G 7/48

(52) U.S. Cl. 703/11

(57) ABSTRACT

Disclosed is a system for predicting programmed ribosomal frameshift sites in genome sequences, in which programmed frameshifts, which are difficult to detect because of their variation with gene types, are classified into −1 frameshifts and +1 frameshifts as basic frameshift models, each consisting of four types of modules, and the modules are combined in various ways, whereby the system can predict frameshifts of various user-defined modules and computationally detect frameshifts at high efficiency. Also, the present invention provides related web service which is accessible regardless of the operating system of the user's computer. Request messages for frameshifts and response messages to the search results of frameshifts are sent and received in XML format, so that they can be flexibly applied to programs using various languages.

### CROSS REFERENCE TO RELATED APPLICATIONS

This application claims priority under 35 USC 119(a)-(d) to South Korea (Republic of Korea) Patent Application No. KR10-2006-106383 filed on Oct. 31, 2006, which is incorporated by reference in its entirety herein.

### BACKGROUND OF THE INVENTION

The present invention relates to a system for finding programmed ribosomal frameshift sites in genome sequences. More particularly, the present invention relates to a system for predicting programmed ribosomal frameshift sites of various user-defined frameshift models, +1 frameshift model for prokaryotic genes, +1 frameshift model for eukaryotic genes as well as common −1 frameshift model.

In general, programmed ribosomal frameshifts are involved in the expression of certain genes in a wide range of organisms such as viruses, bacteria, and eukaryotes, including humans.

In this process, the ribosome shifts to an alternative reading frame at a specific site in messenger RNA (mRNA) in order to respond to special signals from the mRNA. This programmed ribosomal frameshifting plays a meaningful role in biological phenomena, including embryogenesis, genetic controls, selective enzyme production, etc.

Regarding methods for predicting programmed ribosomal frameshifts of prior art, Moon et al. reported a method for predicting frameshifts (Moon, S. et al., LNCS, 2004, 3036: 334-341); Moon et al. reported a method for predicting genes expressed by −1 and +1 frameshift (Moon, S. et al., Nucleic Acids Research, 2004, 32: 4884-4892); Hammell et al. reported a method for identifying putative programmed −1 ribosomal frameshift sites in a vast DNA database (Hammell, A. B. et al., Genomic Res., 1999, 9: 417-427); Bekaert et al. reported a method for predicting a +1 frameshift for a eukaryotic frameshift site (Bekaert, M. et al., Bioinformatics, 2003, 19: 327-335); and Shah et al. reported a method for identifying putative programmed translational frameshift sites (Shah, A. A. et al., Bioinformatics, 2002, 18: 1046-1053).

However, the above-described methods of prior art cannot identify programmed frameshifts perfectly due to the diverse nature of frameshifts. Further, since the above methods are carried out by searching only a number of predefined frameshift models computationally, they cannot handle frameshifts of various types.

### SUMMARY OF THE INVENTION

Accordingly, the present invention provides a system for predicting programmed ribosomal frameshift sites in nucleotide sequences, comprising: a pattern module for representing a pattern of nucleotide sequences adapted to correspond to types of user-defined frameshifts and for specifying the nucleotides contained in the pattern; a signal module for defining signals corresponding to the specified nucleotide sequences; a secondary structure module for designating stem-loops or pseudoknots; and a spacer module for inputting the lengths of spacer sections composed of meaningless sequences of nucleotides, whereby the system combines the modules to predict the ribosomal frameshift sites in nucleotide sequences of user-defined target genes. In the system of the present invention, programmed frameshifts, which are difficult to detect because they vary highly with gene types, are classified into −1 frameshift and +1 frameshifts as basic frameshift models. The frameshift models consist of four types of modules, and the modules are combined in various ways, whereby the system can predict frameshifts of various user-defined models and computationally detect frameshifts at high efficiency. The system can provide related web service which is accessible regardless of the operating system of the user's computer, and is operated in such a manner that request messages for frameshifts and messages in response to the search results of frameshifts are sent and received in XML format, so that they can be flexibly applied to programs using various languages.

In a preferred embodiment of the present invention, said frameshift comprises −1 frameshift, +1 frameshift for a prokaryotic gene or +1 frameshift for a eukaryotic gene.

The −1 frameshift site comprises sequentially a pattern component including X XXY YYZ type pattern, wherein X is N (adenine, guanine, cytosine, thymine), Y is W (adenine or cytosine), Z is H (adenine, cytosine, thymine); a space component with 4 to 11 nucleotides (nts); and a secondary structure component capable of designating stem-loops or pseudoknots.

In addition, the +1 frameshift site for a prokaryotic gene comprises sequentially an upstream signal component which includes a Shine-Dalgarno sequence having sequences of GGGA, AGGG, GGAG or GGGG; a spacer component having sequences of three nucleotides; a downstream signal component having sequences of CUU URA C, wherein the R is uracil or adenine.

Further, the +1 frameshift site for a eukaryotic gene comprises sequentially a signal component including a sequence of UUU UGA, UCC UGA or CCC UGA; a spacer component having a spacer with 4 to 11 nucleotides; and a secondary structure component capable of designating stem-loops or pseudoknots.

In another aspect, the present invention provides a method for predicting programmed ribosomal frameshift sites in nucleotide sequences, comprising: allowing a user to define a desired frameshift model; inputting data into a pattern module for displaying a pattern of nucleotide sequences and for defining the nucleotides contained in the pattern, into a signal module for defining a signal corresponding to a specified nucleotide sequence, into a secondary structure module for designating stem-loops or pseudoknots, and into a spacer module for determining space lengths; and loading genome sequences to find the user-defined frameshift model.

Preferably, the method further comprises taking the most important one of the modules as a pivot; and preferentially searching for matches with the pivot in data of the genome sequences.

In another aspect, the present invention provides a system for predicting user-defined frameshift sites from gemome sequences comprising: a means for editing a user-defined frameshift model which presents basic frameshift models and a component composing the basic frameshift model whereby a user can edit the component or input a new frameshift model; a means for input of a nucleotide sequence whereby the user input a nucleotide sequence of a gene or a full genome or a fragment thereof; a means for operation which is used for identifying whether the basic frameshift models or the user-defined frameshift model exist in the nucleotide sequence; a means for output of the result of the operation.

In an embodiment, the system of the present invention further comprises a means for selecting additional information. In a preferred embodiment, the additional information is a type of the nucleic acid, a length of the nucleic acid or a direction of the nucleic acid.

In another embodiment, the system of the present invention further comprises a means for saving the user-defined frameshift model and/or the result of the operation.

In another preferred embodiment, the basic frameshift model is a common −1 frameshift signal, a +1 frameshift signal for a prokaryotic gene or a +1 frameshift signal for a eukaryotic gene.

In another embodiment, the component is a pattern component representing patterns of a certain polynucleotide, a signal component representing sequence information of a polynucleotide, a secondary structure component representing secondary structures of a polynucleotide, or a spacer component representing oligonucleotide sequence composed of meaningless sequences of nucleotides which are located between the above-mentioned components.

In a preferred embodiment of the present invention, the user-defined frameshift model consists of at least one of components selected from the group consisting of the pattern component, the signal component, the secondary structure component and the spacer component or a combination thereof.

In another preferred embodiment of the present invention, the −1 frameshift signal comprises a pattern component, a spacer component, and a secondary structure component sequentially. In a more preferred embodiment, the pattern component is a pattern of X XXY YYZ, wherein the X is N (A, G, C or T) but the three Xs are same nucleotides, the Y is W (A or C) but the three Ys are same nucleotides, and Z is H (A, C or T). In a more preferred embodiment, the secondary structure component is but not limited to a stem-loop or a pseudoknot or a combination thereof.

In another preferred embodiment of the present invention, the +1 frameshift signal for a prokaryotic gene sequentially comprises an upstream signal component, a spacer component, and a downstream signal component. In a more preferred embodiment, the upstream signal component is a Shine-Dalgarno sequence, and the downstream signal component is a polynucleotide having nucleotide sequence of CUU URA C, wherein the R is guanine (G) or adenine (A). The Shine-Dalgarno sequence comprises a sequence of GGGA, AGGG, GGAG or GGGG.

In another preferred embodiment of the present invention, the +1 frameshift signal for a eukaryotic gene sequentially comprises a signal component, a spacer component and a secondary structure component. In a more preferred embodiment, the signal component is a polynucleotide whose sequence is UUU, UGA, YCC or UGA, wherein the Y is uracil (U) or cytosine (C), and the secondary structure component is a stem-loop or a pseudoknot or a combination thereof.

In a preferred embodiment, the input of a nucleotide sequence is performed by loading a fasta or gbk format file saved in hard disk drive (HDD) or other removable recording media or by direct input through a sequence input window.

In a preferred embodiment, the means for operation is implemented by following algorithm but not limited thereto:

```
Length(A) is the length of array A.
Firstof(match) is the first index of a match.
Lastof(match) is the last index of a match.
Set F be an array of components in the user-defined model.
Set M be a 2-dim array that will save all matches of a component.
Set 1-dim of M as Length(F), and the size of M is flexible.
pi ← index of pivot model
Set M[pi] an array of matches with F[pi], sorted in increasing order
of the first indices of matches.
for i ← pi-1 to 0 do
  count ← 0
    for mi ← 0 to Length(M[i+1]) do
    if mi ≠ 0 and Firstof(M[i, mi])= Firstof(M[i, mi−1]) then
      go to next step.
    end if
Set FM be an array of matches with F[i] in upstream of M[i+1, mi].
Sort FM in increasing order of the first indices of matches.
    for fmi ← 0 to Length(FM)−1 do
      M[i, count] ← FM[fmi]
      Count ← count + 1
    end for
  end for
end for
for i ← pi+1 to Length(F)−1 do
  count ← 0
    for mi ← 0 to Length(M[i−1]) do
    if mi ≠ 0 and Lastof(M[i, mi])= Lastof(M[i, mi−1]) then
      go to next step.
    end if
Set FM be an array of matches with F[i] in downstream of
M[i−1, mi].Sort FM in increasing order of the last indices of matches.
    for fmi ← 0 to Length(FM)−1 do
      M[i, count] ← FM[fmi]
      count ← count + 1
    end for
  end for
end for.
```

In another embodiment of the present invention, the means for output can output a list of the basic frameshift model and the user-defined frameshift model, whereby match results according to the reading frame of each model or a site where the frameshift model is found in the nucleotide sequence and the sequence of the site are outputted.

In addition, the present invention provides a method for predicting a user-defined frameshift model from gonome sequences comprising the following steps:

(a) outputting a provided list of basic frameshift models and a component of the frameshift model selected by a user according to the user's selection;

(b) providing a window for editing the user-defined frameshift model in which the user can input a new frameshift model or edit the component of the selected frameshift model;

(c) providing a window for inputting a nucleotide sequence of a gene or a full genome or a fragment thereof in which the user can input the nucleotide sequence;

(d) searching the user-defined frameshift model is exist in the nucleotide sequence inputted by the user using a means for operation; and

(e) outputting the result of the search through a screen of a computer.

In a preferred embodiment of the method of the present invention, the searching step consists of taking a most important one of the modules as a pivot; and preferentially searching for matches with the pivot in data of the nucleotide sequences but not limited thereto.

The method of the present invention is implemented by a stand-alone application, web service, or web application but not limited thereto.

In an embodiment of the present invention, the steps of (a) to (c) is implemented simultaneously or sequentially but not limited thereto.

In another embodiment, the basic frameshift model is a common −1 frameshift signal, a +1 frameshift signal for a prokaryotic gene or a +1 frameshift signal for a eukaryotic gene.

In another embodiment, the component is a pattern component representing patterns of a certain polynucleotide, a signal component representing sequence information of a polynucleotide, a secondary structure component representing secondary structures of a poylnucleotide, or a spacer component representing oligonucleotide sequence composed of meaningless sequences of nucleotides which are located between the above-mentioned components.

In a preferred embodiment of the present invention, the user-defined frameshift model consists of at least one of components selected from the group consisting of the pattern component, the signal component, the secondary structure component and the spacer component or a combination thereof.

In another preferred embodiment of the present invention, the −1 frameshift signal comprises a pattern component, a spacer component, and a secondary structure component sequentially. In a more preferred embodiment, the pattern component is a pattern of X XXY YYZ, wherein the X is N (A, G, C or T) but the three Xs are same nucleotides, the Y is W (A or C) but the three Ys are same nucleotides, and Z is H (A, C or T). In another preferred embodiment, the secondary structure component is a stem-loop or a pseudoknot or a combination thereof.

In another preferred embodiment of the present invention, the +1 frameshift signal for a prokaryotic gene sequentially comprises an upstream signal component, a spacer component, and a downstream signal component. In this case, the upstream signal component includes a Shine-Dalgarno sequence, and the downstream signal component includes a polynucleotide having nucleotide sequence of CUU URA C, wherein the R is guanine (G) or adenine (A). The Shine-Dalgarno sequence is GGGA, AGGG, GGAG or GGGG but not limited thereto.

In another preferred embodiment of the present invention, the +1 frameshift signal for a eukaryotic gene sequentially comprises a signal component, a spacer component and a secondary structure component. In this case, the signal component includes a polynucleotide whose sequence is UUU, UGA, YCC or UGA, wherein the Y is uracil (U) or cytosine (C), and the secondary structure component includes a stem-loop or a pseudoknot.

In a preferred embodiment, the input of a nucleotide sequence is performed by loading a fasta or gbk format file saved in hard disk drive (HDD) or other removable recording media or by direct input through a sequence input window.

In a preferred embodiment, the means for operation is implemented by the above-described algorithm but not limited thereto.

In another aspect, the present invention provides a computer system for predicting a frameshift site, wherein the computer system comprising: (a) a memory; and (b) a processor interconnected with the memory and having one or more software components loaded therein, wherein the one or more software components cause the processor to execute steps of the above-mentioned method of the present invention.

Further, the present invention provides a computer program product comprising a computer readable medium having one or more software components encoded thereon in computer readable form, wherein the one or more software components may be loaded into a memory of a computer system and cause a processor interconnected with said memory to execute steps of the above-mentioned method of the present invention.

### BRIEF DESCRIPTION OF THE DRAWINGS

The above and other objects, features and advantages of the present invention will be more clearly understood from the following detailed description taken in conjunction with the accompanying drawings.

FIG. 1A is a schematic view showing a basic frameshift model for −1 frameshift.

FIG. 1B is a schematic view showing a basic frameshift model for +1 frameshift in a prokaryotic gene.

FIG. 1C is a schematic view showing a basic frameshift model for +1 frameshift in a eukaryotic gene.

FIG. 2 schematically shows edit panels which help users input data into the pattern module and the secondary structure module of the system for predicting frameshift sites in genomic sequence according to the present invention.

FIG. 3 schematically shows a graphical user interface of the system for predicting ribosomal frameshift sites in genomic sequences according to the present invention.

FIG. 4 schematically shows a request message and a response message for the web service of the system for finding ribosomal frameshift sites in genomic sequences according to the present invention.

FIG. 5 schematically shows an input page and a result page of the web application of the system for predicting ribosomal frameshift sites in genomic sequences according to the present invention.

FIG. 6 is a schematic diagram showing an example of web application system capable of implementing the method of the present invention.

FIG. 7A is a schematic flow chart of a method of predicting ribosomal frameshift sites in genomic sequences according to the present invention. FIG. 7B is a view illustrating the algorithm of the system for predicting ribosomal frameshift sites in genomic sequences according to the present invention.

### DETAILED DESCRIPTION OF THE INVENTION

### Definitions

The term “frameshift” refers generally to a genetic mutation that inserts or deletes a number of nucleotides that is not evenly divisible by three from a DNA sequence. However, in this document, it refers to “a ribosomal frameshift” or “a programmed frameshift”, a process in which a ribosome shifts to an alternative reading frame by one or few nucleotides at a specific site in a messenger RNA (Baranov, P. V., et al., Gene, 2002, 286: 187-201) unless not defined in particular.

The phrase “−1 frameshift” refers to a frameshift in which a ribosome shifts a nucleotide in the upstream direction and “+1 frameshift” refers to a frameshift in which a ribosome shifts a nucleotide in the downstream direction.

The phrase “nucleic acid” refers to a complex, high-molecular-weight biochemical macromolecule composed of nucleotide chains that convey genetic information. The most common nucleic acids are deoxyribonucleic acid (DNA) and ribonucleic acid (RNA).

The term “polynucleotide” refers to nucleic acid polymers typically having no more than about 500 base pairs.

The phrase “reading frame” refers to a contiguous and non-overlapping set of three-nucleotide codons in DNA or RNA.

The term “ORF (open reading frame)” refers to a portion of an organism's genome which contains a sequence of bases that could potentially encode a protein.

The phrase “user-defined frameshift model” refers to a frameshift model that a user defines its structure arbitrarily based on his or her own research.

The phrase “Shine-Dalgarno sequence” refers to the signal for initiation of protein biosynthesis in bacterial mRNA. It is located 5′ of the first coding AUG, and consists primarily, but not exclusively, of purines.

The phrase “secondary structure” refers to the general three-dimensional form of local segments of biopolymers such as proteins and nucleic acids (DNA/RNA).

The term “stem-loop” refers to a pattern that can occur in single-stranded DNA or, more commonly, in RNA. When the loop is short, the structure is also known as a hairpin or hairpin loop.

The term “pseudoknot” refers to an RNA secondary structure containing two stem-loop structures in which the first stem's loop forms part of the second stem.

The term “XML (extensible Markup Language)” refers to a W3C-recommended general-purpose markup language that supports a wide variety of applications.

The term “SOAP (Simple Object Access Protocol)” refers to a protocol for exchanging XML-based messages over computer networks, normally using HTTP. SOAP forms the foundation layer of the Web services stack, providing a basic messaging framework that more abstract layers can build on.

The term “stand-alone” is defined as a program not needing the services of other programs once it is running.

The phrase “web server” refers to a computer that is responsible for accepting HTTP requests from clients, which are known as Web browsers, and serving them HTTP responses along with optional data contents, which usually are Web pages such as HTML documents and linked objects (images, etc.).

The phrase “web application” refers to an application that is accessed with a Web browser over a network such as the Internet or an intranet.

Reference now should be made to the drawings, in which the same reference numerals are used throughout the different drawings to designate the same or similar components.

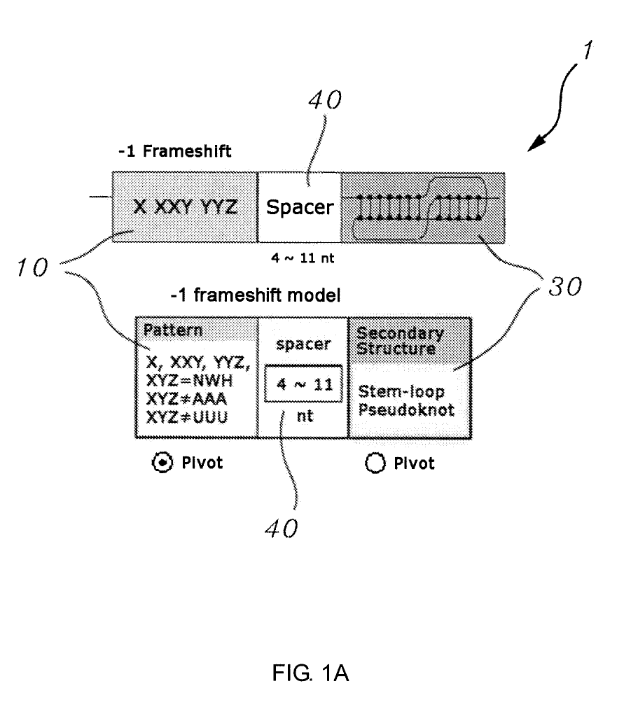

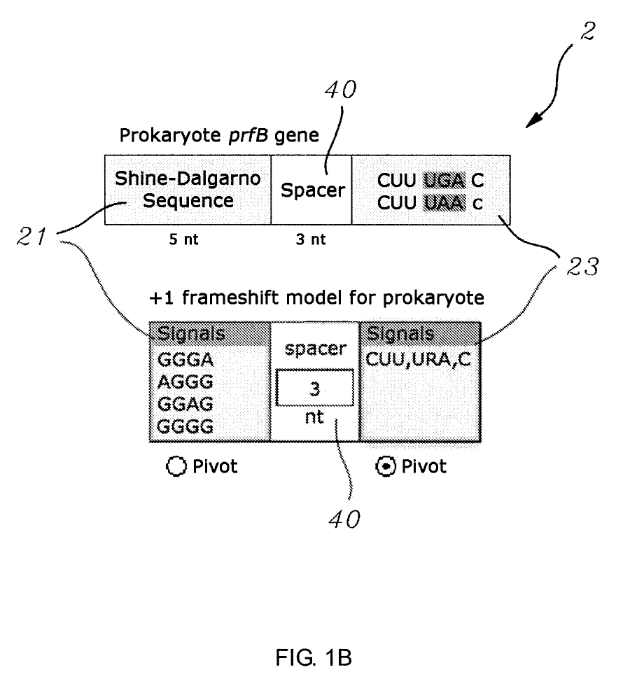

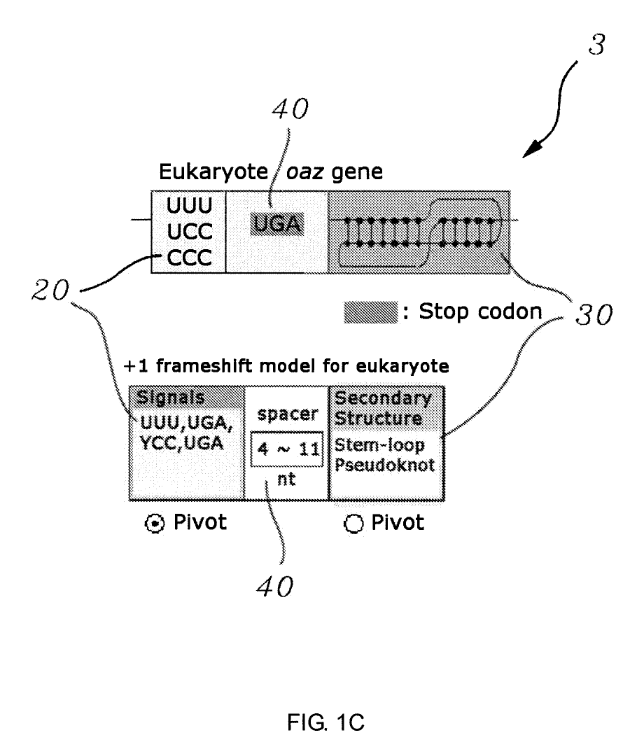

FIG. 1A is a schematic view showing a basic frameshift model for a −1 frameshift. FIG. 1B is a schematic view showing a basic frameshift model for a +1 frameshift in a prokaryotic gene. FIG. 1C is a schematic view showing a basic frame shift model for a +1 frameshift in a eukaryotic gene. As seen in FIGS. 1A to 1C, these three types of frameshifts are considered basic frameshifts in the present invention.

Each frameshift model consists of a combination of a pattern module 10, a signal module 20, a secondary module 30, a spacer module 40, and a counter module.

The pattern module 10 represents a pattern of nucleotide strings adapted to correspond to types of user-defined frameshifts. The nucleotides contained in the pattern are set forth. In this regard, the pattern is defined first, followed by the nucleotide strings corresponding to the pattern, so as to form a structure like a slippery site of the −1 frameshift model. A pattern component corresponding to the pattern module comprises a pattern (X XXY YYZ) such as a slippery site of −1 frameshift.

Defining the signals corresponding to certain nucleotide sequences, the signal module 20 represents a nucleotide string such as Shine-Dalgarno sequences, stop codons, etc.

The secondary structure module 30 is provided for separately designating stem-loops or pseudoknots, or a set of stem-loops and pseudoknots according to user definition. A secondary structure component corresponding to the secondary structure module comprises stem-loops or pseudoknots.

The spacer module 40 is provided for inputting, in nucleotide units [nt], the lengths of spacer sections which are not expressed as proteins according to combinations of nucleotides.

The system of the present invention can further comprise a counter module. The counter module is used for inputting the number of nucleotide strings in a specified region, and is useful for finding regions including specific nucleotides, such as GC-rich regions.

The three basic frameshift models, each consisting of the above-mentioned components, are exemplified by a −1 frameshift 1, a +1 frameshift 2 for a prokaryotic gene, and a +1 frameshift 3 for a eukaryotic gene.

In the −1 frameshift 1, a pattern component 10 having a signal sequence of X XXY YYZ, a spacer component 40 having 4-11 nucleotides, and a secondary structure component 30 for designating stem-loops or pseudoknots are sequentially arranged in the X-axis direction.

In the signal sequence, X is adenine (A), guanine (G), cytosine (C) or thymine (T), Y is adenine (A) or cytosine (C), and Z is adenine (A), cytosine (C) or thymine (T). For use in the signal component 20, X, Y and Z may be replaced by N, W, and H, respectively.

The +1 frameshift 2 for a prokaryotic gene comprises an upstream signal component 21 having a Shine-Dalgarno sequence of GGGA, AGGG, GGAG or GGGG, a spacer component 40 having a space of 3 nucleotides, and a downstream signal component 23 having a sequence of CUU URA C, which are sequentially arranged in an X-axis direction.

In a preferred embodiment, the downstream signal component 23 has a sequence of CUU URA C, wherein the R is adenine or guanine.

As for the +1 frameshift 3 for a eukaryotic gene, it comprises a signal component 20 having a sequence of UUU UGA or UCC YGA, a spacer component 40 having a spacer of 4-11 nucleotides, and a secondary structure component 30 for designating one selected from among a stem-loop, a pseudoknot, or a combination of a stem-loop and a pseudoknot, and these components are sequentially arranged in an X-axis direction.

In the signal component 20, Y represents U (uracil) or C (cytosine), and thus UUU UGA, UCC UGA and CCC UGA are a combination available for the signal component 20.

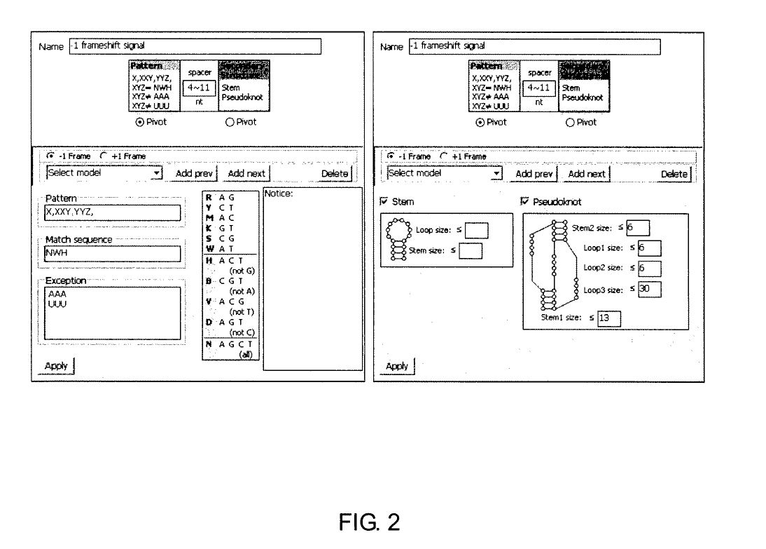

FIG. 2 schematically shows edit panels which help users input data into the pattern module and the secondary structure module of the system for predicting frameshift sites in nucleotide sequence according to the present invention. As shown in FIG. 2, a check box is provided on the left side of the edit panels.

Along with the definition of a match sequence, an exception box is provided for defining a sequence to be excluded from matches, or for setting it as a default.

On the right of the edit panel, boxes are provided in which data of the second structure module 30, that is, a stem-loop size, a stem size of pseudoknot, and sizes of a first loop, a second loop, and a third loop, are inputted.

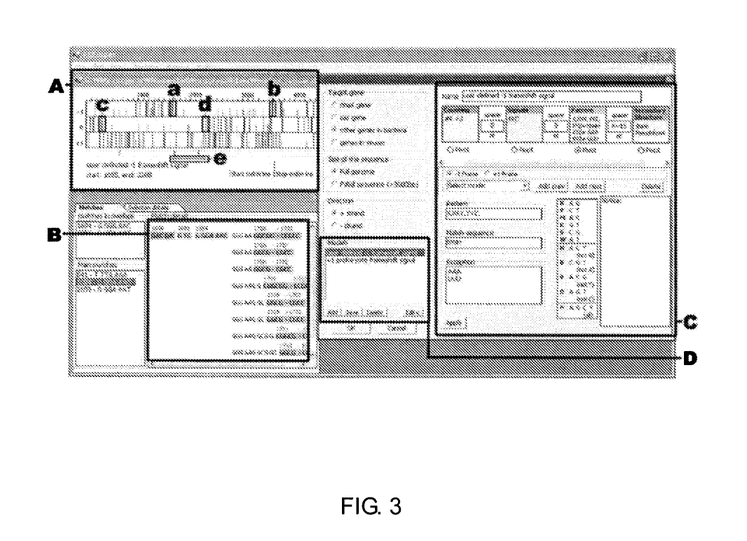

FIG. 3 schematically shows a graphical user interface of the system for predicting ribosomal frameshift sites in genomic sequences according to the present invention. As seen in this figure, panel A is adapted to find frameshift sites in overlapping regions of two ORFs (open reading frames).

The starting positions of the two ORFs are extended from their original start codons a to upstream stop codons c. If position a of frame −1 is on the left of position d of frame 0 and there exists a start codon in frame 0, the extended regions a to b and c to d of the two ORFs partially overlap at their termini.

The definition of an overlapping region identifies a wider region than the actual overlapping region in order to avoid missing possible frameshift sites, since the overlapping region is extended to the upstream stop codon.

The data on the definitions set by the user can be saved in an XML (extensible Markup Language) file.

In panel B are shown results of finding the data and modules defined by the user. Panel C is an edit panel in which the data set by the user is modified or deleted. Panel D shows kinds and lists of user-defined frameshifts.

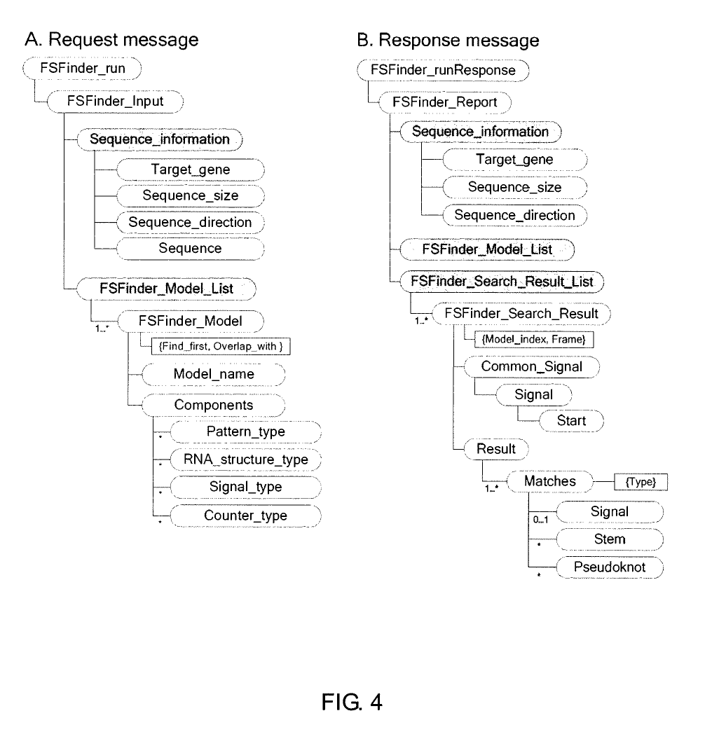

FIG. 4 shows a request message and a response message for the web service of the system for finding ribosomal frameshift sites in nucleotide sequences. Panel A handles the request message for web service. As shown in this figure, it requires the input of sequence information and kinds and numbers of frameshifts when the system for predicting ribosomal frameshift sites in nucleotides sequences is operated.

The sequence information includes information on kinds of target genes to be found, sequence direction for determining upstream direction and downstream direction, and the nucleotide sequence.

In addition, the frameshift provides information on its kind and number, pattern type, RNA structure, signal type and counter type.

Panel B accounts for a response message to the request message. The response to the sequence information includes information on target genes, nucleotide size, and upstream and downstream directions.

Also, it includes a list of user-defined frameshifts, common signals in signals and start, matches among signals, stem-loops and pseudoknots and match results.

Access to the web service is possible through the web page. A client can flexibly use the service of the server by sending and receiving SOAP (Simple Object Access Protocol) messages in the XML format, which means that if the user knows the input XML schema, output XML schema and address of the web service, the user can use the web service without using the web page. Also, since the request and reply messages are sent and received in the XML format, they can be flexibly applied to programs using various languages.

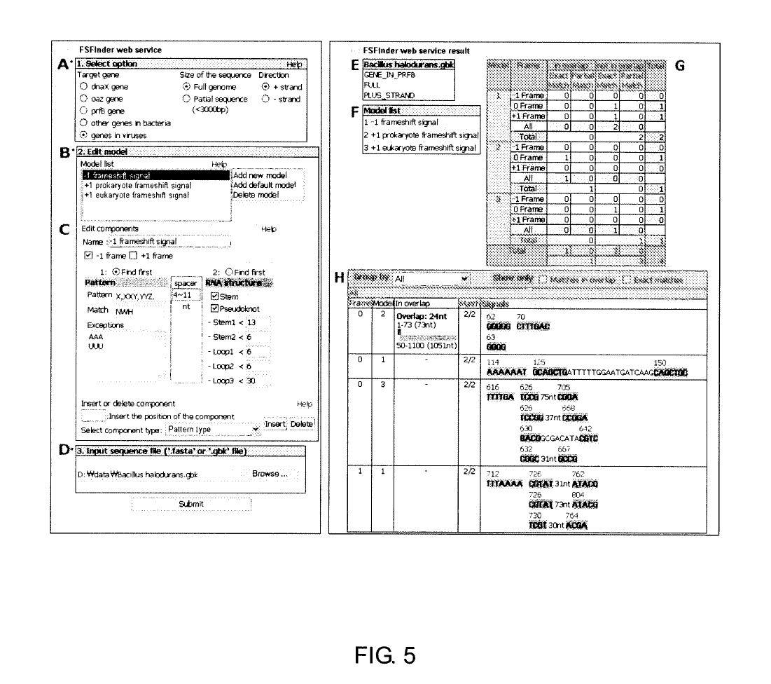

With reference to FIG. 5, an input page (left) and a result page (right) of the web application of the system for predicting ribosomal frameshift sites in genomic sequences according to the present invention are shown. In panel A, as seen in this figure, selection is made according to options. This option selection panel allows the user to choose the type of target genes, and the size and direction of the nucleotide sequence.

Panel B is adapted to define a new model and add a default model with regard to the −1 frameshift 1, the +1 frameshift for a prokaryotic gene and the +1 frameshift 3 for a eukaryotic gene, or to delete each of the frameshifts.

Panel B is adapted to define the components of the newly added models, including names. In panel B, also, the user can set preference arbitrarily and choose items to be excluded from the search and types to be matched with patterns.

Panel D is provided with a browser box for choosing an input sequence file, and thus can find sequence data stored in the computer and removable storage devices.

The right panel of FIG. 5 shows a result page of the web application. In box E, file names of input sequences, target genes, sequence sizes and directions are displayed to the users. Panel G is provided for displaying the number of results matched with user-defined frameshifts after the system for finding ribosomal frameshift sites in genomic sequences according to the present invention is operated.

Herein, the results are separated into exact matches and partial matches in each of the overlapping and non-overlapping regions. Exact matches and partial matches are individually displayed as total numbers according to the −1 frameshift 1, the +1 frameshift 2 for a prokaryotic gene and the +1 frameshift 3 for a eukaryotic gene.

In panel H, the results are grouped into model types, frames containing the frameshift sites, and the overlapping regions of ORFs. The locations and lengths of the overlapping ORFs are also displayed. Match rates and sequences corresponding to matched modules are shown in different colors according to module types. For example, the pattern module 10 may be represented in yellow, the secondary structure module 30 in green, the signal module 20 in sky blue, and the counter module in red. The red numbers above the sequences designate the positions of the first nucleotides of the sequences matched with their corresponding modules.

The web application is designed to use the web service via web pages and thus is accessible regardless of the operating system or web browser of user's computer.

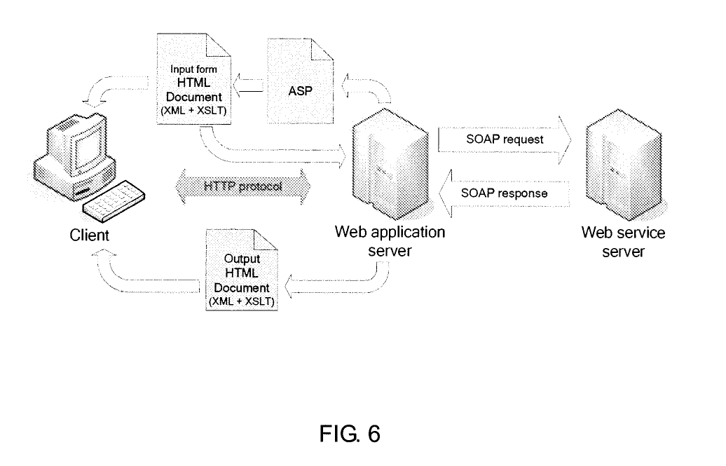

FIG. 6 is a schematic diagram showing an example of web application system capable of implementing the method of the present invention. The web application is embodied in that a user can use the method through web page. Thus, the application is accessible regardless types of user's operation system and web browser.

The client connects to the web application server with HTML (hypertext markup language) document using HTTP protocol. The web application server makes the request SOAP message and sends it. When the web service server sends back the result of the request, the web application server makes an XML document for the response SOAP message and returns the XML documen in the current style sheet.

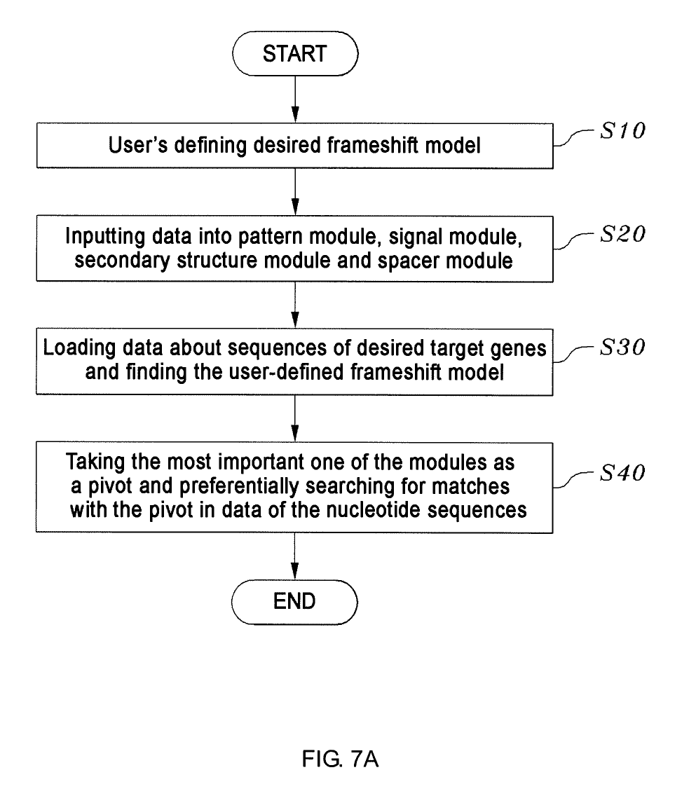

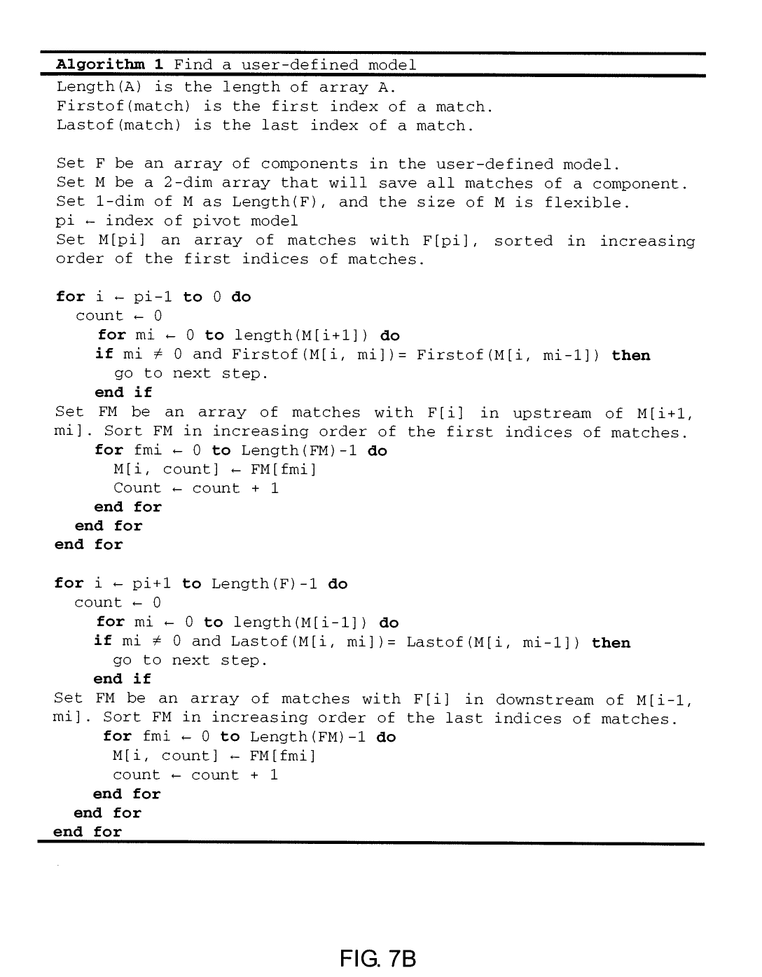

FIG. 7A is a schematic flow chart of a method of predicting ribosomal frameshift sites in genomic sequences according to the present invention, and FIG. 7B is a view illustrating an algorithm of the system for predicting ribosomal frameshift sites in genomic sequences according to the present invention. As shown in the figures, the user defines a desired frameshift model (S10). Then, data are input into the pattern module 10 for displaying a pattern of nucleotide sequences and defining the nucleotides contained in the pattern, the signal module 20 for defining a signal corresponding to a specified nucleotide sequence, the secondary structure module 30 for designating stem-loops or pseudoknots, and the spacer module 40 for determining space lengths (S20). Thereafter, data on sequences of desired target genes are loaded to find user-defined frameshift models (S30).

The user takes the most important of the modules as the pivot and, based on the user's choice, matches with the pivot are preferentially searched for (S40).

That is, since an arbitrary number of modules can be combined, the most important module should be specified as a pivot by the user. Matches with the pivot module, if any, are found first. Then, matches to modules other than the pivot are sequentially found in left and right directions from the pivot module, starting with the one closest to the pivot module.

In a combination of five user-defined modules composed of 1, 2, 3, 4 and 5 in this order, for example, if the module 3 is specified as a pivot, either the system of the present invention may search module 4, close to the pivot, and then module 5, before modules 2 and 1, or the system may search module 2, close to the pivot, and then the module 2 before modules 4 and 5.

As described hitherto, the present invention provides a system for predicting programmed ribosomal frameshift sites in genomic sequences on the basis of the aforementioned structure. In the system, programmed frameshifts, which are difficult to detect because they vary highly with gene types, are classified into −1 frameshift and +1 frameshifts as basic frameshift models, each consisting of four types of modules, and the modules are combined in various ways, whereby the system can predict frameshifts of various user-defined modules and computationally detect frameshifts at high efficiency. In addition, the system provides related web service, which is accessible regardless of the operating system of the user's computer. Furthermore, request messages for frameshifts and response messages to the search results of frameshifts are sent and received in XML format, so that they can be flexibly applied to programs using various languages.

Having now fully described the present invention in some detail by way of illustration and examples for purposes of clarity of understanding, it will be obvious to one of ordinary skill in the art that the same can be performed by modifying or changing the invention within a wide and equivalent range of conditions, dimensions and other parameters without affecting the scope of the invention or any specific embodiment thereof, and that such modifications or changes are intended to be encompassed within the scope and spirit of the appended claims. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

All references cited herein are hereby incorporated by reference in their entirety to the extent that there is no inconsistency with the disclosure of this specification. All headings used herein are for convenience only.

What is claimed is:

1. A system for predicting ribosomal frameshift sites in nucleotide sequences, comprising:
a pattern module for representing a pattern of nucleotide sequences adapted to correspond to types of user-defined frameshifts and for specifying the nucleotides contained in the pattern;
a signal module for defining signals corresponding to the specified nucleotide sequences;
a secondary structure module for designating stem-loops or pseudoknots; and
a spacer module for inputting the lengths of spacer sections composed of meaningless sequences of nucleotides,
whereby the system combines the modules to predict the ribosomal frameshift sites in nucleotide sequences of user-defined target genes.

2. The system according to claim 1, wherein the frameshift is sub-classified into −1 frameshift, +1 frameshift for a prokaryotic gene, and +1 frameshift for a eukaryotic gene.

3. The system according to claim 1, wherein the −1 frameshift 1 comprises, in a sequential array:
a pattern component having a sequence of X XXY YYZ, wherein X is N (adenine, guanine, cytosine, or thymine), Y is W (adenine, or cytosine), and Z is H (adenine, cytosine or thymine);
a spacer component consisting of 4-11 nucleotides; and
a secondary structure component for designating stem-loops or pseudoknots.

4. The system according to claim 1, wherein the +1 frameshift for a prokaryotic gene comprises, in a sequential array:
an upstream signal component having a Shine-Dalgano sequence of GGGA, AGGG, GGAG or GGGG;
a spacer component having a space of 3 nucleotides; and
a downstream signal component having a sequence of CUU URA C.

5. The system according to claim 4, wherein the nucleotide R is adenine or guanine.

6. The system according to claim 1, wherein the +1 frameshift for a prokaryotic gene comprises, in a sequential array:
a signal component having a sequence of UUU UGA, UCC UGA, or CCC UGA;
a spacer component consisting of 4 to 11 nucleotides; and
a secondary structure component for designating stem-loops or pseudoknots.

7. A method for predicting ribosomal frameshift sites in genomic sequences, comprising:
allowing a user to defining a desired frameshift model;
inputting data into a pattern module for displaying a pattern of nucleotide sequences and defining the nucleotides contained in the pattern, into a signal module for defining a signal corresponding to a specified nucleotide sequence, into a secondary structure module for designating stem-loops or pseudoknots, and into a spacer module for determining space lengths; and
loading data about sequences of desired target genes to find the user-defined frameshift model.

8. The method according to claim 7, further comprising:
taking a most important one of the modules as a pivot; and
preferentially searching for matches with the pivot in data of the genomic sequences.

9. A system for predicting user-defined frameshift sites from genome sequences comprising: a means for editing a user-defined frameshift model which presents basic frameshift models and a component composing the basic frameshift model whereby a user can edit the component or input a new frameshift model; a means for input of a nucleotide sequence of a gene or a full genome or a fragment thereof whereby the user input a nucleotide sequence; a means for operation which is used for identifying whether the basic frameshift models or the user-defined frameshift model exist in the nucleotide sequence; a means for output of the result of the operation.

10. The system according to claim 9, further comprising a means for selection capable of selecting additional information.

11. The system according to claim 10, wherein the additional information is a type of the nucleic acid, a length of the nucleic acid or a direction of the nucleic acid.

12. The system according to claim 9, further comprising a means for saving capable of saving the user-defined frameshift model and/or the result of the operation.

13. The system according to claim 9, wherein the basic frameshift model is a −1 frameshift signal, a +1 frameshift signal for a prokaryotic gene or a +1 frameshift signal for a eukaryotic gene.

14. The system according to claim 9, wherein the component is a pattern component representing patterns of a certain polynucleotide, a signal component representing sequence information of a polynucleotide, a secondary structure component representing secondary structures of a poylnucleotide, or a spacer component representing oligonucleotide sequence composed of meaningless sequences of nucleotides which is located between the above-mentioned components.

15. The system according to claim 9, wherein the user-defined frameshift model consists of at least one of components selected from the group consisting of the pattern component, the signal component, the secondary structure component and the spacer component or a combination thereof.

16. The system according to claim 13, wherein the −1 frameshift signal comprises a pattern component, a spacer component, and a secondary structure component sequentially.

17. The system according to claim 15, wherein the pattern component is X XXY YYZ, wherein the X is N (A, G, C or T) but the three Xs are same nucleotides, the Y is W (A or C) but the three Ys are same nucleotides, and Z is H (A, C or T).

18. The system according to claim 14, wherein the secondary structure component is a stem-loop or a pseudoknot or a combination thereof.

19. The system according to claim 13, wherein the +1 frameshift signal for a prokaryotic gene comprises an upstream signal component, a spacer component, and a downstream signal component sequentially.

20. The system according to claim 19, wherein the upstream signal component is a Shine-Dalgarno sequence.

21. The system according to claim 20, wherein the Shine-Dalgarno sequence is GGGA, AGGG, GGAG or GGGG.

22. The system according to claim 19, wherein the downstream signal component is a polynucleotide having nucleotide sequence of CUU URA C, wherein the R is guanine or adenine.

23. The system according to claim 13, wherein the +1 frameshift signal for a eukaryotic gene comprises a signal component, a spacer component and a secondary structure component sequentially.

24. The system according to claim 23, wherein the signal component is a polynucleotide whose sequence is UUU, UGA, YCC or UGA, wherein the Y is uracil or cytosine.

25. The system according to claim 23, wherein the secondary structure component is a stem-loop or a pseudoknot or a combination thereof.

26. The system according to claim 9, wherein the input of a nucleotide sequence is performed by loading a fasta or gbk format file saved in hard disk drive or other removable recording media or by direct input through a sequence input window.

27. The system according to claim 9, wherein the means for output outputs a list of the basic frameshift model and the user-defined frameshift model, whereby match results according to the reading frame of each model or a site where the frameshift model is found in the nucleotide sequence and the sequence of the site are outputted.

28. A method for predicting a user-defined frameshift model from genome sequences comprising the following steps:
(a) outputting a provided list of basic frameshift models and a component of the frameshift model selected by a user according to the user's selection;
(b) providing a window for editing the user-defined frameshift model in which the user can input a new frameshift model or edit the component of the selected frameshift model;
(c) providing a window for inputting a nucleotide sequence of a gene or a full genome or a fragment thereof in which the user can input the nucleotide sequence;
(d) searching the user-defined frameshift model is exist in the nucleotide sequence inputted by the user using a means for operation; and
(e) outputting the result of the search through a screen of a computer.

29. The method according to claim 28, wherein the searching step consists of taking a most important one of the modules as a pivot; and preferentially searching for matches with the pivot in data of the nucleotide sequences but not limited thereto.

30. The method according to claim 28, which is implemented by a stand-alone application, web service, or web application.

31. The method according to claim 28, wherein the steps of (a) to (c) is implemented simultaneously.

32. The method according to claim 28, wherein the basic frameshift model is a common −1 frameshift signal, a +1 frameshift signal for a prokaryotic gene or a +1 frameshift signal for a eukaryotic gene.

33. The method according to claim 28, the component is a pattern component representing patterns of a certain polynucleotide, a signal component representing sequence information of a polynucleotide, a secondary structure component representing secondary structures of a poylnucleotide, or a spacer component representing an oligonucleotide sequence composed of meaningless sequences of nucleotides which are located between the above-mentioned components.

34. The method according to claim 28, wherein the user-defined frameshift model consists of at least one of components selected from the group consisting of the pattern component, the signal component, the secondary structure component and the spacer component or a combination thereof.

35. The method according to claim 32, wherein the −1 frameshift signal comprises a pattern component, a spacer component, and a secondary structure component sequentially.

36. The method according to claim 35, wherein the pattern component is X XXY YYZ, wherein the X is N (A, G, C or T) but the three Xs are same nucleotides, the Y is W (A or C) but the three Ys are same nucleotides, and Z is H (A, C or T).

37. The method according to claim 35, wherein the secondary structure component is a stem-loop or a pseudoknot or a combination thereof.

38. The method according to claim 32, wherein the +1 frameshift signal for a prokaryotic gene comprises an upstream signal component, a spacer component, and a downstream signal component sequentially.

39. The method according to claim 38, wherein the upstream signal component is a Shine-Dalgarno sequence.

40. The method according to claim 39, wherein the Shine-Dalgamo sequence is GGGA, AGGG, GGAG or GGGG.

41. The method according to claim 38, wherein the downstream signal component is a polynucleotide having nucleotide sequence of CUU URA C, wherein the R is guanine or adenine.

42. The method according to claim 32, wherein the +1 frameshift signal for a eukaryotic gene comprises a signal component, a spacer component and a secondary structure component sequentially.

43. The method according to claim 42, wherein the signal component is a polynucleotide whose sequence is UUU, UGA, YCC or UGA, wherein the Y is uracil or cytosine.

44. The method according to claim 42, wherein the secondary structure component is a stem-loop or a pseudoknot or a combination thereof.

45. The method according to claim 28, wherein the input of a nucleotide sequence is performed by loading a fasta or gbk format file saved in hard disk drive or other removable recording media or by direct input through a sequence input window.

46. A computer system for predicting a frameshift site, wherein the computer system comprising: (a) a memory; and (b) a processor interconnected with the memory and having one or more software components loaded therein, wherein the one or more software components cause the processor to execute steps of the method of claim 28.

47. A computer program product comprising a computer readable medium having one or more software components encoded thereon in computer readable form, wherein the one or more software components may be loaded into a memory of a computer system and cause a processor interconnected with said memory to execute steps of the method of claim 28.
